(19) United States
(12) Patent Application Publication
(10) Pub. No.: US 2007/0239831 A1
(43) Pub. Date: Oct. 11, 2007

(54) Interface for editing, binding, and displaying an annotation for a message

(75) Inventor: Amit J. Basu, San Jose, CA (US)

Correspondence Address: Yahoo! Inc.;c/o DARBY & DARBY P.C., P.O. BOX 770, Church Street Station, NEW YORK, NY, 10150-6257, US

(73) Assignee: Yahoo! Inc., Sunnyvale, CA (US)

(21) Appl. No.: 11/398,831

(22) Filed: Apr. 6, 2006

(51) Int. Cl. G06F 15/16; G06F 3/00

(52) U.S. Cl. 709/206; 715/752

(57) ABSTRACT

Methods and systems are directed toward associating, displaying, and managing notes or other annotations with emails, instant messages, or other messages. A user interface provides a listing of message headers. Selecting an annotation area associated with a message header causes an editor to open, and allows a user to enter an annotation, such as a text note, a URL, and/or other data. An annotation fragment, such as a snippet of text, is generated from the annotation and associated with the annotation and message. The annotation, the annotation fragment, an icon or another representation remains perceptibly associated with the corresponding message header whenever the message header is moved in the user interface. Placing a cursor over, or selecting the annotation representation causes the full annotation to be accessed and displayed. Clicking on, or otherwise selecting the annotation representation opens the editor to revise the full annotation.

### FIELD OF ART

The present invention relates generally to messaging, and more particularly, but not exclusively, to providing an annotation for messages in a display list.

### BACKGROUND

Stationary and mobile client devices often include one or more messaging capabilities such as email, instant messaging (IM), short message service (SMS), multimedia message service (MMS), and the like. Messages are typically exchanged over an electronic network, often through an online messaging service. A user can generally view a listing of messages, such as received messages, sent messages, messages grouped in a user-defined directory, and the like. For each message, a message listing typically displays a subject line, a sender identifier, a date, a data size, or similar information that is not set by a receiving user. Characteristics of messages in a listing can also be identified with an icon, a text font effect, or other single-meaning indicator. For example, high priority messages can be identified with a red exclamation point. Unread messages can be identified with bold text. Messages with attachments may be identified with a clip icon. A few of these characteristics can be controlled by a receiving user. For instance, a receiving user may mark a message as unread, which may change the subject line to bold text. However, receiving users generally do not have descriptive control over listed messages. Some message listings display a short segment of the content of a message. Some message listings also include a preview pane to display additional content of a selected message in the listing, without opening the entire message in a new window. However, these content preview techniques generally do not enable receiving users to modify the content or add notes.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client and/or server device that may be included in a system implementing the invention;

FIG. 3 shows a screen shot of a computer display illustrating an annotation fragment and a full annotation associated with a message in a message listing interface;

FIG. 4 shows a screen shot of a computer display illustrating an editing interface for editing an annotation;

FIG. 5 is a flow diagram illustrating exemplary logic for displaying an annotation fragment;

FIG. 6 is a flow diagram illustrating exemplary logic for displaying a full annotation; and

FIG. 7 is a flow diagram illustrating exemplary logic for editing an annotation.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense. Briefly stated, embodiments of the present invention are directed towards providing a method and system for associating, displaying, and managing notes or other annotations with messages. The embodiment described below discusses annotations associated with messages in a listing maintained by an online message service and accessed by a browser. However, the invention is not so limited and may include a stand-alone message system, a peer-to-peer message system, a listing of data items other than messages, and other variations.

Illustrative Operating Environment

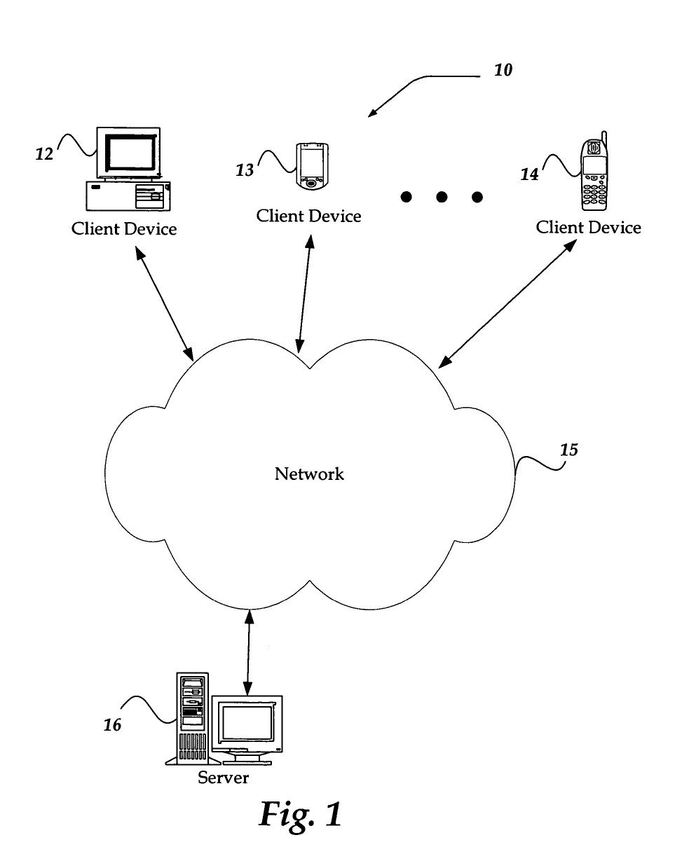

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, and a server 16. Network 15 is in communication with and enables communication between each of client devices 12-14 and server 16.

Client devices 12-14 may include virtually any computing device capable of receiving and sending a message over a network, such as network 15, to and from another computing device, such as server 16, each other, and the like. The set of such devices may include devices that are usually considered more general purpose devices and typically connect using a wired communications medium such as personal computers, multiprocessor systems, microprocessor-based or programmable consumer electronics, network PCs, and the like. The set of such devices may also include mobile devices that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to control settings, such as an annotation setting, and to instruct the client device to perform operations. Each client device also includes a communication interface that enables the client device to send and receive messages from another computing device employing the same or a different communication mode, including, but not limited to email, IM, SMS, MMS, internet relay chat (IRC), Mardam-Bey's internet relay chat (mIRC), Jabber, and the like. Client devices 12-14 may be further configured with a browser application that is configured to receive and to send web pages, web-based messages, and the like. The browser application may be configured to receive and display graphics, text, multimedia, and the like, employing virtually any web based language, including, but not limited to Standard Generalized Markup Language (SGML), HyperText Markup Language (HTML), Extensible Markup Language (XML), a wireless application protocol (WAP), a Handheld Device Markup Language (HDML), such as Wireless Markup Language (WML), WMLScript, JavaScript, and the like.

Network 15 is configured to couple one computing device to another computing device to enable them to communicate. Network 15 is enabled to employ any form of medium for communicating information from one electronic device to another. Also, network 15 may include a wireless interface, such as a wired interface, such as the Internet, in addition to local area networks (LANs), wide area networks (WANs), a cellular network interface, direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 15 includes any communication method by which information may travel between client devices 12-14 and/or server 16. Network 15 is constructed for use with various communication protocols including transmission control protocol/internet protocol (TCP/IP), user datagram protocol (UDP), WAP, code division multiple access (CDMA), global system for mobile communications (GSM), and the like.

Server 16 may comprise a messaging server, a web server, and/or other server. Server 16 may provide one or more services, such as an email service, an IM service, an SMS service, a news service, a sales service, a financial management service, and the like. Other servers and/or other network nodes may communicate data between client devices and/or a subset of services, such as between phone carriers, between data services providers, and/or between other service providers. Server 16 and/or other network devices may perform data conversions, routing, filtering, and/or other services.

The media used to store and/or transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data generated as or received as a modulated data signal over wires, air, or other transport mechanism and includes any information delivery media. By way of example, communication media includes wireless media such as acoustic, RF, infrared, gaseous, liquid, and other wireless media, and wired media such as twisted pair, coaxial cable, fiber optics, wave guides, and other wired media.

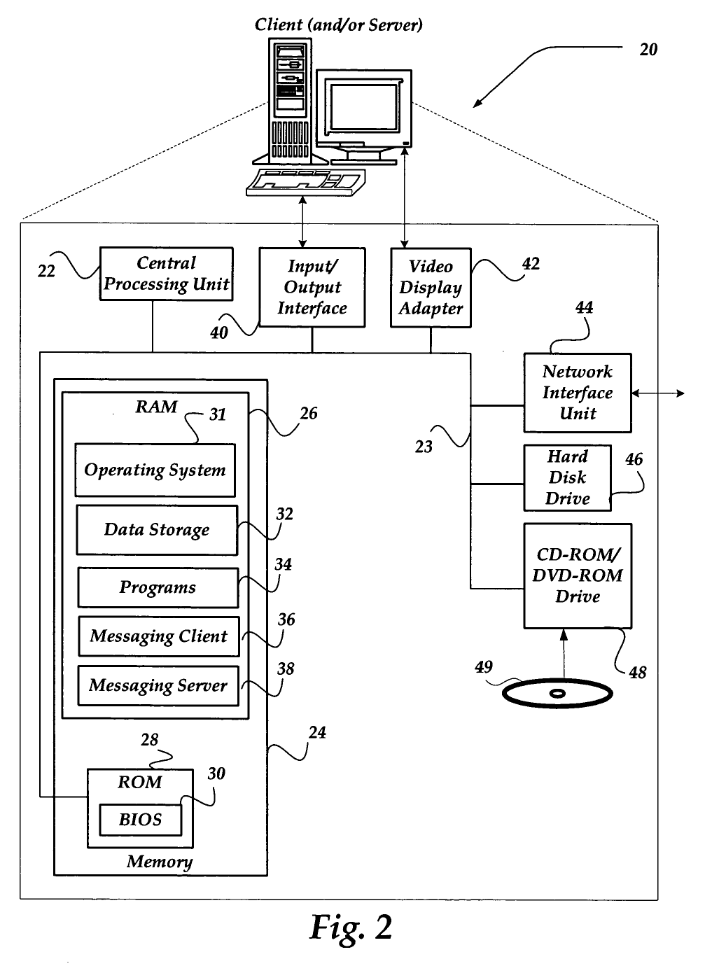

One embodiment of a general purpose computing device, such as a client device 20, is described in more detail below in conjunction with FIG. 2. Briefly, client device 20 may include any computing device, including those capable of connecting to network 15 to enable a user to communicate with other client devices and/or server 16. Client device 20 may include many more components than those shown. The components shown, however, are sufficient to disclose an illustrative embodiment for practicing the invention. Many of the components of client device 20 may also be duplicated in server 16 and/or other server devices.

As shown in the figure, client device 20 includes a processing unit 22 in communication with a mass memory 24 via a bus 23. Mass memory 24 generally includes a RAM 26, a ROM 28, and other storage means. Mass memory 24 illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 24 stores a basic input/output system (“BIOS”) 30 for controlling low-level operation of client device 20. The mass memory also stores an operating system 31 for controlling the operation of client device 20. It will be appreciated that this component may include a general purpose operating system such as a version of Windows™, UNIX, LINUX™ and the like. The operating system may also include, or interface with a virtual machine module, such as a Java virtual machine module, that enables control of hardware components and/or operating system operations via application programs, such as Java.

Mass memory 24 further includes one or more data storage units 32, which can be utilized by client device 20 to store, among other things, programs 34 and/or other data. Programs 34 may include computer executable instructions which can be executed by client device 20 to implement browsers, schedulers, calendars, web services, transcoders, database programs, word processing programs, spreadsheet programs, and so forth. Programs 34 may also include computer executable instructions which can be executed by client device 20 (and/or server 16) to implement an HTTP handler application for transmitting, receiving and otherwise processing HTTP communications. Similarly, programs 34 can include an HTTPS handler application for handling secure connections, such as initiating communication with an external application in a secure fashion. Accordingly, programs 34 can process web pages, audio, video, and enable telecommunication with another user of another electronic device. In addition, client device 20 may include a messaging client 36, which may comprise computer executable instructions, and which may be run under control of operating system 31 to enable email, instant messaging, SMS, and/or other messaging services. Similarly, client device 20 and/or a server device configured much like client device 20, can include another messaging module, such as a messaging server 38, which may further provide routing, access control, and/or other server-side messaging services.

Client device 20 also includes an input/output interface 40 for communicating with input/output devices such as a keyboard, mouse, wheel, joy stick, rocker switches, keypad, printer, scanner, and/or other input devices not specifically shown in FIG. 2. A user of client device 20 can use input/output devices to interact with a user interface that may be separate or integrated with operating system 31, programs 34, messaging client 36, and/or messaging server 38. Interaction with the user interface includes visual interaction via a display, and a video display adapter 42.

For higher capability client devices such as a personal computer, client device 20 may include a removable media drive 48 and/or a permanent media drive 46 for computer-readable storage media. Removable media drive 48 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 49, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 44, client device 20 can communicate with a wide area network such as the Internet, a local area network, a wired telephone network, a cellular telephone network, or some other communications network, such as network 15 in FIG. 1. Network communication interface unit 44 is sometimes known as a transceiver, transceiving device, network interface card (NIC), and the like.

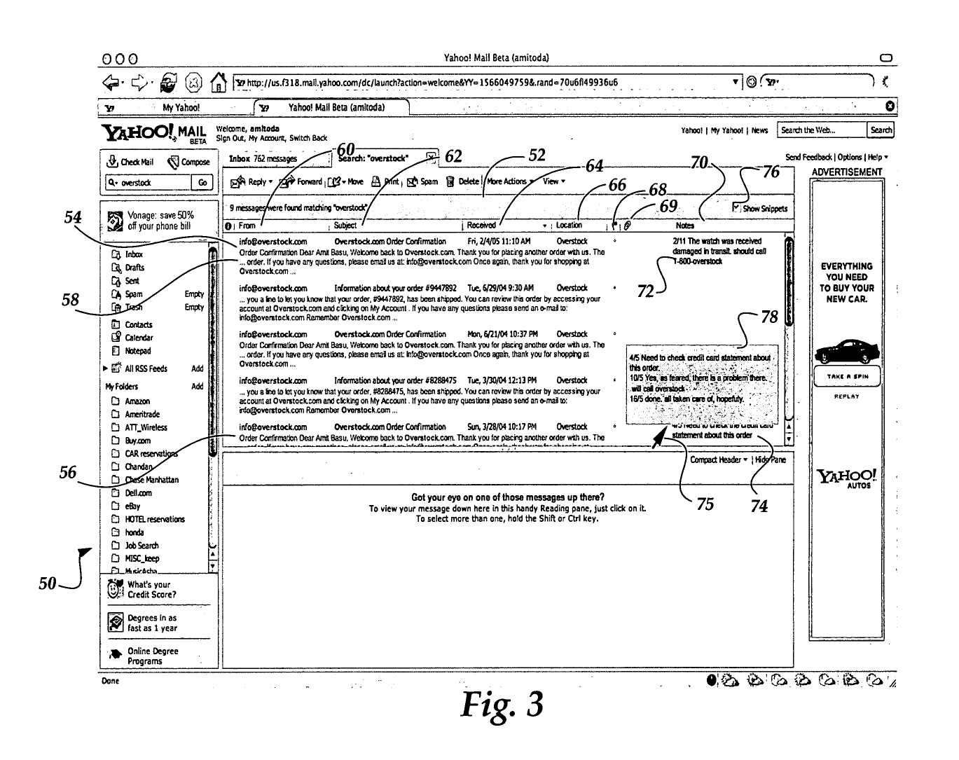

FIG. 3 shows a screen shot of a computer display illustrating an annotation fragment and a full annotation bound with, or otherwise associated with, a message in a messaging interface 50. In this exemplary embodiment, messaging interface 50 is provided through a browser in communication with a messaging service and may be implemented with one or more portal servers, carrier gateway servers, and/or other messaging servers. A message listing pane 52 displays a number of message headers (sometimes referred to as message summaries), such as message header 54 through message header 56. A message header represents and enables access to a corresponding full message. Each message header may be displayed with a message fragment 58 that may comprise an initial portion of message content. Other header information may be displayed in a column format. For example, a “From” column 60 may identify a sender of a message. A “Subject” column 62 may display a subject line of a message. A “Received” column 64 may display a date and time at which the message was received. A flag column 68 may display an indicator, such as a priority level or other characteristic. An attachment column 69 may indicate whether a file is associated with a message.

A “Notes” column 70 displays an annotation fragment, such as note fragments 72 and 74, if an annotation is associated with a message. An annotation fragment, referred to here also as an annotation snippet, may include a portion of text, audio data, visual data, and/or other information that a user wishes to associate with a message. An annotation fragment may be displayed when a message header is scrolled into view. The display of annotation fragments may also be toggled on or off with annotation display control 76. Any other control may be used, such as a radio button, a drop down selection, or other user interface control. As a result of toggling, or as an alternative to displaying annotation fragments, a flag or other icon may be displayed in notes column 70 to indicate or represent the presence of annotations. An annotation icon may be useful to indicate or represent an annotation for limited display area devices, such as cellular phones, PDAs, point-of-sale devices, and the like.

If a user hovers a cursor 75 over an annotation icon or annotation fragment, such as annotation fragment 74, a full annotation 78 is displayed in a dialogue box, such as a ToolTips™ box. In addition, or alternatively, an annotation fragment or a full annotation may be displayed when the cursor hovers over any portion of a message header. A user may also sort messages based on the date and/or time annotations were revised. For example, the user may click on a column heading for notes column 70 to initiate a sort.

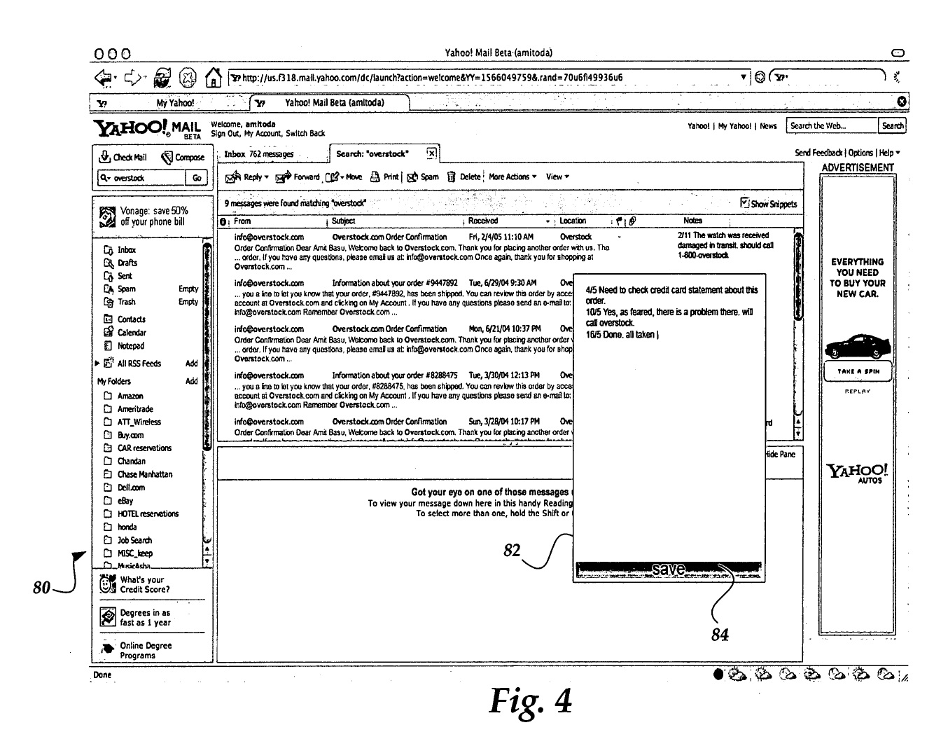

FIG. 4 shows a screen shot of a computer display illustrating a messaging interface 80 with an editing interface for editing an annotation. If a user selects an editing button or otherwise issues an editing instruction to edit an annotation, an annotation editing window 82 is displayed and enables the user to enter and/or edit an annotation. For example, the user may click on an annotation fragment or on a full annotation to activate annotation editing window 82. Any other control may be used, such as a button, a right-mouse-button menu, a drop down selection, or other user interface control. The user may enter or revise information that will remain associated with the corresponding message. For instance, after receiving an email from a colleague about a specific company, the user could check the company's web site and add the web site URL as an annotation to the email, using annotation editing window 82. The user may select a save button 84 to store a new or revised annotation. Numerous other editing buttons and controls may be implemented with annotation editing window 82. The next time the user reviews the listing of emails, the annotation will again be displayed in association with the email, and can be revised through annotation editing window 82. Other editors may also be used, such as an audio editor, a visual editor, and the like. For instance, the user may record or edit a voice message to be associated with an email message.

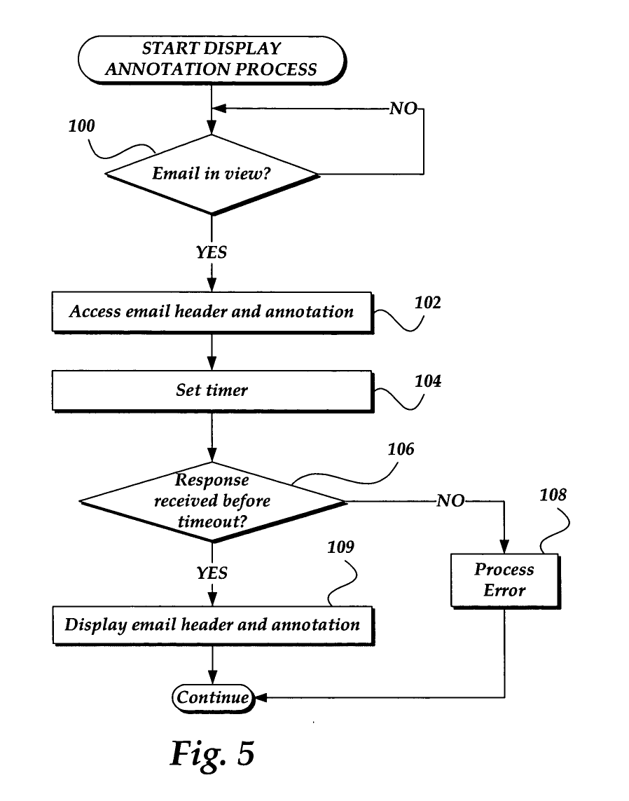

FIG. 5 is a flow diagram illustrating exemplary logic for displaying an annotation fragment. This embodiment may be implemented using asynchronous Java™ and XML (AJAX) or other code for a browser or other client application. At a decision operation 100, a messaging client determines whether a message header is scrolled into a view area of a message listing pane. When a message header is scrolled into view, the messaging client accesses message header data and annotation data, at an operation 102. An HTTP request or other communication request may be sent to a message server to obtain the data. Alternatively, if the message header and annotation data were previously retrieved, the messaging client may access the data from a local data store. A local data store may also be used for a standalone messaging system. Message data may include a message identifier, a sender identifier, a subject, a message size, a message storage location, an attachment flag, an attachment size, an attachment file name, an attachment storage location, a read flag, an importance flag, a folder identifier, a message fragment, a message content, and/or other data. Annotation data may include an annotation flag, an annotation fragment, an annotation size, a date and/or time at which an annotation was last modified, an annotation file name, an annotation storage location, an annotation content, and the like.

At an operation 104, the messaging client sets a timer for detecting a response or otherwise accessing the message header data and annotation data. At a decision operation 106, the messaging client determines whether a response or the data was accessed before a predefined timeout period has expired. The messaging client may wait for a predetermined period of time, make multiple attempts, and/or check another cutoff threshold. If the timeout period expired, the messaging client processes an error at an operation 108. If a response is received or the data is otherwise accessed in time, the messaging client displays the message header and annotation data, at an operation 109. The messaging client may display the entire annotation if it fits within the display area allocated for annotations. Conversely, the messaging client may display an annotation icon if the annotation fragment will not fit within the display area allocated for annotations.

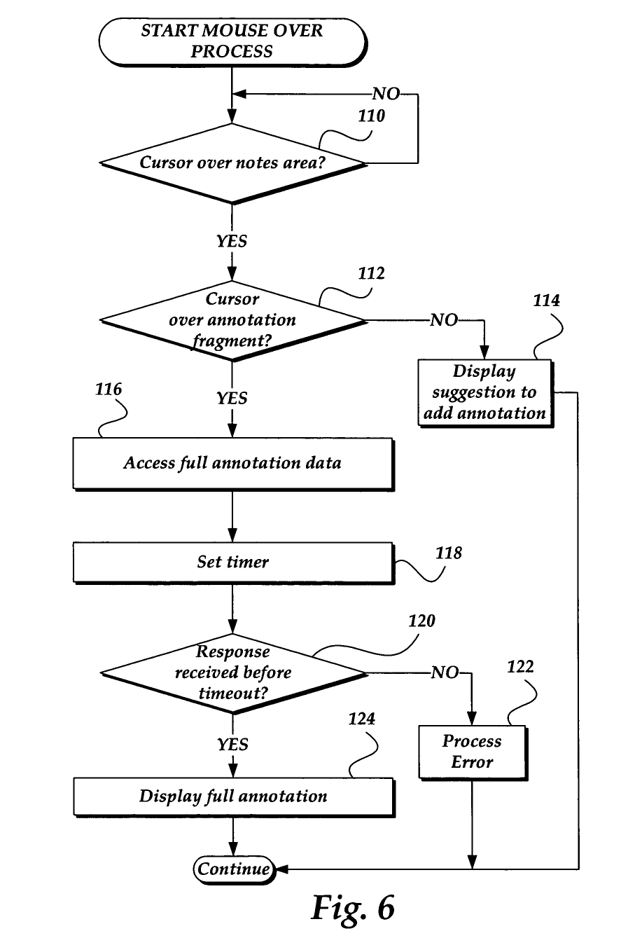

FIG. 6 is a flow diagram illustrating exemplary logic for displaying a full annotation. At a decision operation 110, the messaging client or an annotation module determines whether a cursor is hovering over a notes area in a message display listing. When the messaging client detects the cursor over the notes area, the messaging client determines, at a decision operation 112, weather the cursor is over an annotation fragment. Alternatively, the messaging client may detect whether the cursor is over an annotation icon or simply over a message header. If the cursor is over the notes area, but not over an annotation fragment, the messaging client displays a suggestion, at an operation 114, to add an annotation. For example, the messaging client may display a pop-up dialog box advising the user to click to add a note.

If the cursor is over the notes area, and over an annotation fragment, the messaging client accesses full annotation data, at an operation 116. The messaging client may access the full annotation data from a server or from a local data store. This step may be skipped if other optional logic determines that the full annotation is already displayed within the display area allocated for annotation fragments.

At an operation 118, the messaging client sets a timer for detecting a response or otherwise accessing the full annotation data. At a decision operation 120, the messaging client determines whether a response or the data was accessed before a corresponding predefined timeout period has expired. The messaging client may wait for a predetermined period of time, make multiple attempts, and/or check another cutoff threshold. If the timeout period expired, the messaging client processes an error at an operation 122. If a response is received or the data is otherwise accessed in time, the messaging client displays the full annotation data, at an operation 124. The full annotation data is generally displayed in pop-up dialog box, but may be displayed in a side pane, in a separate window, or in other ways. The method of displaying the full annotation data may depend on display area limitations, processor capability, and/or other factors.

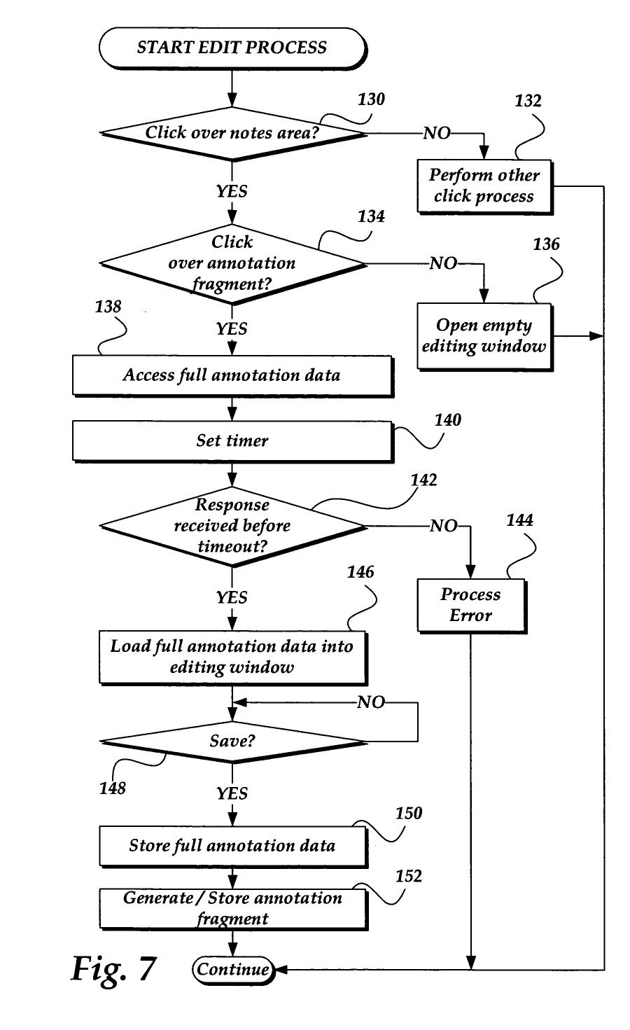

FIG. 7 is a flow diagram illustrating exemplary logic for editing an annotation. At a decision operation 130, the messaging client or annotation module determines whether a mouse click is detected in the notes area of the message display listing. If the messaging client detected a click in another area, the messaging client performs other appropriate process(es) at an operation 132. When the messaging client detects a click in the notes area, the messaging client determines, and a decision operation 134, weather the click occurred over an annotation fragment. Alternatively, the messaging client may detect whether the click occurred over an annotation icon. The messaging client may also, or alternatively, determine whether the click occurred over a message header, although a special click may be more appropriate, such as a right mouse button click and/or selection of a menu button. If the click is over the notes area, but not over an annotation fragment, the messaging client opens an empty editing window, at an operation 136, to enable the user to enter an annotation. For example, the messaging client may display a pop-up editing box, launch a full editing application program, or provide another editing tool. If the click is over the notes area, and over an annotation fragment, the messaging client accesses full annotation data, at an operation 138. The messaging client may access the full annotation data from a server or from a local data store.

At an operation 140, the messaging client sets a timer for detecting a response or otherwise accessing the full annotation data. At a decision operation 142, the messaging client determines whether a response or the data was accessed before a corresponding predefined timeout period has expired. The messaging client may wait for a predetermined period of time, make multiple attempts, and/or check another cutoff threshold. If the timeout period expired, the messaging client processes an error at an operation 144. If a response is received or the data is otherwise accessed in time, the messaging client loads the full annotation data into the annotation editing window, at an operation 146. The method of displaying the annotation editing tool may depend on display area limitations, processor capability, and/or other factors. The user may then revise the full annotation data.

At a decision operation 148, the messaging client determines whether a save instruction has been input. When a save instruction is detected, the messaging client stores the revised full annotation data, at an operation 150. The storage may be local or remote with a communication to a server. Other editing commands may be handled in a similar manner. At an operation 152, the messaging client (or messaging server) generates or revises a corresponding annotation fragment based on the full annotation data. A first predefined number of words from the full annotation data may be selected for the annotation fragment, a save or revision date may be included in the annotation fragment, and/or other full annotation data may be incorporated into the annotation fragment. The annotation fragment is stored with an association to the full annotation data.

The above specification, examples, and data provide a complete description of the manufacture and use of the composition of the invention. However, other embodiments and aspects will be evident to those skilled in the art. For example, corresponding server-side processes include receiving requests for, and transmit messages, message headers, annotation fragments, full annotation data, annotation indicators, and the like. One or more servers and/or a client may store the various data in databases, files, caches, and/or other storage systems. The annotation data and message data may be organized according to predefined and/or user-defined folders and subfolders. Accessing and/or associating annotation data can be keyed to a user identifier, a message identifier, and/or other identifiers. A server or client may also track user actions associated with annotations and determine behaviors, which may enable the server or client to offer information or services that are relevant to each users actions and/or behaviors. Another embodiment includes linking annotation data to a calendar and/or other application. For example, a user may enter date information into an annotation, and a corresponding calendar entry is made and/or other link formed. In another embodiment, the annotations can be searched, sorted, filtered, or otherwise managed. A user may then select an annotation to access a corresponding message, calendar entry, and/or other data. Since many embodiments of the invention can be made without departing from the spirit and scope of the invention, the invention resides in the claims hereinafter appended.

1. A method for providing an annotation, comprising:
receiving an instruction to associate an annotation with an electronic message, wherein the instruction is based on a selection through a user interface that provides an electronic message representation;
executing an editor that enables a user to enter the annotation;
associating the annotation with the electronic message;
providing an annotation representation with the electronic message representation in the user interface such that the annotation representation is perceptibly associated with the electronic message representation.

2. The method of claim 1, further comprising generating an annotation fragment from the annotation and providing the annotation fragment as the annotation representation.

3. The method of claim 1, wherein receiving the instruction comprises detecting a mouse click in an annotation area of the user interface and the annotation area is adjacent to the electronic message representation.

4. The method of claim 1, wherein the annotation representation comprises at least one of the following; an icon and an annotation fragment.

5. The method of claim 1, further comprising:
detecting that the electronic message representation is moving within a message listing display area of the user interface;
accessing the annotation representation; and
displaying the annotation representation within the message listing display area of the user interface.

6. The method of claim 1, further comprising:
detecting a scroll instruction in the user interface; and
maintaining a display of the annotation representation adjacent to the electronic message representation as the electronic message representation scrolls.

7. The method of claim 1, further comprising:
detecting a user selection of the annotation representation;
accessing the annotation; and
providing the annotation through the user interface.

8. The method of claim 1, further comprising:
detecting a user selection of the annotation representation;
accessing the annotation; and
enabling the user to revise the annotation with the editor.

9. A computer readable medium storing executable instructions for performing the actions of claim 1.

10. A system for providing an annotation, comprising:
a user interface device;
a processor in communication with the user interface device; and
a memory in communication with the processor and storing instructions that cause the processor to perform a plurality of actions, including:
receiving a command to associate an annotation with an electronic message, wherein the command is based on a selection through the user interface device that provides an electronic message representation;
executing an editor that enables a user to enter the annotation through the user interface device;
associating the annotation with the electronic message;
providing an annotation representation with the electronic message representation through the user interface device such that the annotation representation is perceptibly associated with the electronic message representation.

11. The system of claim 10, further comprising a communication interface coupled to a network, and wherein the instructions further cause the processor to perform the action of accessing the electronic message representation from an online message service.

12. The system of claim 10, wherein the instructions further cause the processor to perform the actions of:
detecting a user selection of the annotation representation;
accessing the annotation; and
providing the annotation through the user interface device.

13. The system of claim 10, wherein the instructions further cause the processor to perform the actions of:
detecting a user selection of the annotation representation;
accessing the annotation; and
enabling the user to revise the annotation with the editor.

14. The system of claim 10, wherein the system comprises a mobile device.

15. A method for providing a messaging service, comprising:
providing an electronic message representation to a client, wherein the electronic message representation is associated with an electronic message;
receiving an annotation, wherein the annotation is created with an editor and based at least in part on a selection of the electronic message representation;
associating the annotation with the electronic message;
generating an annotation representation based at least in part on the annotation; and
sending to the client the annotation representation with an identifier that enables the client to associate the annotation representation with the electronic message representation.

16. The method of claim 15, further comprising:
receiving a request for the annotation; and
sending to the client the annotation with an identifier that enables the client to associate the annotation with the electronic message representation.

17. The method of claim 15, further comprising:
receiving a revised annotation;
associating the revised annotation with the electronic message;
generating a revised annotation representation based at least in part on the revised annotation; and
sending to the client the revised annotation representation with the identifier that enables the client to associate the revised annotation representation with the electronic message representation.

18. A system for providing a messaging service, comprising:
a communication interface coupled to a network;
a processor in communication with the communication interface; and
a memory in communication with the processor and storing instructions that cause the processor to perform a plurality of actions, including:
providing an electronic message representation to a client, wherein the electronic message representation is associated with an electronic message;
receiving an annotation, wherein the annotation is created with an editor and based at least in part on a selection of the electronic message representation;
associating the annotation with the electronic message;
generating an annotation representation based at least in part on the annotation; and
sending to the client the annotation representation with an identifier that enables the client to associate the annotation representation with the electronic message representation.

19. The system of claim 18, wherein the instructions further cause the processor to perform the actions of:
receiving a request for the annotation; and
sending to the client the annotation with an identifier that enables the client to associate the annotation with the electronic message representation.

20. The system of claim 18, wherein the instructions further cause the processor to perform the actions of:
receiving a revised annotation;
associating the revised annotation with the electronic message;
generating a revised annotation representation based at least in part on the revised annotation; and
sending to the client the revised annotation representation with the identifier that enables the client to associate the revised annotation representation with the electronic message representation.
